(19) United States
(12) Patent Application Publication
(10) Pub. No.: US 2007/0172630 A1
(43) Pub. Date: Jul. 26, 2007

(54) PRIMARY CARPET BACKINGS COMPOSED OF BI-COMPONENT FIBERS AND METHODS OF MAKING AND USING THEREOF

(76) Inventors: David M. Jones, Dacula, GA (US); Carl Wust, Conyers, GA (US)

Correspondence Address: GARDNER GROFF SANTOS & GREENWALD, P.C., 2018 POWERS FERRY ROAD, SUITE 800, ATLANTA, GA, 30339, US

(21) Appl. No.: 11/565,007

(22) Filed: Nov. 30, 2006

Related U.S. Application Data
(60) Provisional application No. 60/740,932, filed on Nov. 30, 2005.

(51) Int. Cl. D03D 27/00; B32B 5/26; B32B 5/06; B32B 33/00

(52) U.S. Cl. 428/95; 442/268; 442/270; 442/364; 442/381; 442/388; 156/72

(57) ABSTRACT

Described herein are primary carpet backings composed of bi-component fibers. The backings described herein can be easily recycled and re-used. Also described herein are methods for making and recycling primary carpet backings.

This application claims priority to U.S. Provisional Application Ser. No. 60/740,932, filed Nov. 30, 2005, which is hereby incorporated herein by reference in its entirety for all purposes.

### BACKGROUND

In the conventional manufacture of carpet, yarns are tufted or pushed through a primary backing material. Primary backings are typically woven or non-woven fabrics made of one or more natural or synthetic fibers or yarns, such as jute, wool, polypropylene, polyethylene, polyamides, polyesters, and rayon. Films of synthetic materials, such as polypropylene, polyethylene and ethylene-propylene copolymers, also can be used to form the primary backing.

The tufts of yarn inserted into the primary backing during the tufting process are usually held in place by untwisting of the yarn as well as shrinkage of the primary backing. In the finishing operation, the backside or stitched surface of the primary backing usually is coated with an adhesive, a.k.a. a back coat, such as a natural or synthetic rubber, resin latex, emulsion or a hot melt adhesive, to enhance locking or anchoring of the tufts to the backing. Basic requirements for adhesives include the ability to bond strongly to the primary backing, the tuft stitches protruding through its backside, and the secondary backing. Another backing material is brought into contact with the adhesive under pressure, with melting and subsequent cooling of the adhesive serving to bond the backing materials. An alternative to carpet lamination processes using hot melt adhesives involves forming hot melt polymers or other thermoplastics into a continuous sheet or film and directing it between primary and secondary backings, heating the backings in contact with the molten thermoplastic adhesive, and then solidifying the hot melt adhesive to form a high strength laminate or composite.

Generally, a tufted carpet is further stabilized in the finishing operation by laminating a secondary backing, for example, a thermoplastic film or a woven or non-woven fabric made from polypropylene, polyethylene, or ethylene-propylene copolymers or natural fibers such as jute, to the tufted primary backing. The adhesive used in the finishing operation bonds the primary backing to the secondary backing.

The above-described methods for making carpet are used in most carpet made in the United States. However, these methods have both process and environmental disadvantages. First, the latex hinders the recycling of the used carpet and scrap product (e.g., salvage and off-spec carpet) because the latex is a thermoset and cannot generally be re-melted or re-used. Additionally, the latex causes sticking in molds and other recycling devices and releases odors upon heating. Finally, the latex requires excessive energy to recycle product containing the latex. With the decreasing availability and increasing cost of suitable landfills for such scrap, the carpet industry has experienced a need for finding other alternatives.

Indeed, the issue of recycling with respect to scrap alone is a serious problem, notwithstanding the fact that the face yarns and backings typically used in a carpet are made from all-thermoplastic materials. Once these components are contaminated with the filled latex, which includes a very significant component of inorganic filler, e.g., calcium carbonate, they are difficult to recycle economically, because of the aforementioned technical problems.

Traditional approaches to recycling and reuse have involved separating the individual components to be reused or settling with mixtures of components, which often render the recycled materials suitable for products of a lower quality. Separating individual components of multilayered products, while often more feasible than separating more homogeneous mixtures, can nevertheless present significant difficulties where the layers are held together with adhesive. Often, the separation processes render one or more of the components unusable or usable only after significant additional processing. For example, processes that involve heating polyurethanes to very high temperatures can often result in irreversible degradation of the polyurethane molecule, which renders it unsuitable for recycle or reuse.

An approach for improving recycling has been disclosed by Hoechst Celanese Corporation of Salisbury, N.C., in a paper entitled “All-Polyester Carpet System: Environmental and Performance Aspects,” presented by L. G. Stockman, et al. at the International Durable Needlepunch Conference on Apr. 20, 1994 (previously summarized in “The Carpet Recycling Newsletter”) Volume 93, No. 7 (September 1993). See also, European Pat. Appl. 0 568 916 A1, published Nov. 10, 1993. According to this report, carpet may be constructed using a tufted polyester felt primary backing together with a polyester secondary backing, each backing containing a certain percentage of hetero-filled fiber with a low-melt sheath (binder fibers) intimately mixed with non-binder fibers. The backings are then needled together and heat-treated. This results in the production of an all-polyester carpet; however, this carpet possesses modest physical properties. In addition, this approach uses a non-woven primary backing and a non-woven secondary backing, both of which are heavier than woven polypropylene backing typically used in the industry.

Thus, what is needed is a carpet backing that does not require the use of adhesives to bind tufts to the backing. Additionally, the carpet backing should be easily recyclable to address environmental concerns. The carpet backings described herein address these and other needs present in the carpet industry.

### SUMMARY

Described herein are primary carpet backings composed of bi-component fibers that possess improved physical properties such as tuft binding strength. The backings described herein can be easily recycled and re-used. Also described herein are methods for talking and recycling primary carpet backings. The advantages of the invention will be set forth in part in the description which follows, and in part will be obvious from the description, or may be learned by practice of the aspects described below. The advantages described below will be realized and attained by means of the elements and combinations particularly pointed out in the appended claims. It is to be understood that both the foregoing general description and the following detailed description are exemplary and explanatory only and are not restrictive.

### BRIEF DESCRIPTION OF THE DRAWINGS

The accompanying drawings, which are incorporated in and constitute a part of this specification, illustrate several aspects described below. Like numbers represent the same elements throughout the figures.

FIG. 1 shows a diagram of a bi-component fiber 14 with core 10 and sheath 12.

FIG. 2 shows a diagram of a face fiber 20 tufted through a backing comprising bi-component fibers.

FIG. 3A shows a photograph of bi-component fibers 14 after heating to demonstrate adhesion properties and ability to flow. FIG. 3B shows a cross section of a single bi-component fiber 14.

FIG. 4A shows a top view of a single layer non-woven fabric comprising a mechanically bonded blend of low-melt fibers and high-melt fibers. FIG. 4B shows a side view of the single layer non-woven fabric shown in 4A (CD=cross direction).

FIG. 5 shows a two-layer non-woven fabric composed of bi-component fibers and woven backing.

FIG. 6 shows a diagram of how to produce a bi-component fiber 14 with a core 10 and sheath 12.

### DETAILED DESCRIPTION

Before the present compounds, compositions, articles, devices, and/or methods are disclosed and described, it is to be understood that the aspects described below are not limited to specific synthetic methods, as such may, of course, vary. It is also to be understood that the terminology used herein is for the purpose of describing particular aspects only and is not intended to be limiting.

In this specification and in the claims that follow, reference will be made to a number of terms that shall be defined to have the following meanings:

It must be noted that, as used in the specification and the appended claims, the singular forms “a,” “an,” and “the” include plural referents unless the context clearly dictates otherwise. Thus, for example, reference to “an adhesion agent” includes mixtures of adhesion agents; reference to “a fiber” includes mixtures of two or more fibers, and the like.

“Optional” or “optionally” means that the subsequently described event or circumstance may or may not occur, and that the description includes instances where the event or circumstance occurs and instances where it does not.

References in the specification and concluding claims to parts by weight, of a particular element or component in a composition or article, denotes the weight relationship between the element or component and any other elements or components in the composition or article for which a part by weight is expressed.

Thus, in a compound containing 2 parts by weight of component X and 5 parts by weight component Y, X and Y are present at a weight ratio of 2:5, and are present in such ratio regardless of whether additional components are contained in the compound.

A weight percent of a component, unless specifically stated to the contrary, is based on the total weight of the formulation or composition in which the component is included.

As used herein “low-melt” or “low melting” with respect to a polymer refers to a thermoplastic polymer that will melt and flow providing adhesion to another material at a melt temperature lower than the high-melt polymer in the present invention.

As used herein “high-melt ” or “high melting” with respect to a polymer refers to a thermoplastic polymer with a melt temperature higher than the processing temperature needed to heat activate the “low-melt polymer” for adhesion properties.

As used herein, the phrase “heat activate . . . for adhesion properties” means the temperature effective to melt and flow the thermoplastic in order for it to encapsulate the tufted fibers. Upon cooling the adhesive thermoplastic fibers will provide adhesion in the way of tuft bind.

A. Primary Carpet Backings

Described herein are primary carpet backings with improved physical properties. In one aspect, the primary backing comprises (1) a first fabric, and (2) a second fabric comprising a high melting polymer and a low melting polymer, wherein the high melting polymer and a low melting polymer are the same polymer, and wherein the first fabric and the second fabric are physically attached to one another.

In another aspect, the primary backing comprises (1) a first fabric, and (2) a second fabric comprising a high melting polymer and a low melting polymer, wherein the low melting polymer is grafted with an unsaturated carboxylic acid, anhydride, ester, or any combination thereof, and wherein the first fabric and the second fabric are physically attached to one another.

The first fabric of the primary backing is composed of any fiber typically used in the carpet industry to make backings. Examples of fibers useful for the first fabric include polyolefins, polyester, and polyamides. In one aspect, the first fabric is composed of polypropylene or nylon. Although the first fabric can be woven or non-woven, it is preferred that first fabric be woven to ensure good attachment to the second fabric. In one aspect, the first fabric is woven polypropylene and techniques for making the same are known in the art. In general, the melting point of the first fabric is higher than that of the low melting polymer of the second fabric.

The second fabric is composed of a high melting polymer and a low melting polymer. This fiber is referred to herein as a bi-component fiber. The high melting polymer and a low melting polymer can be the same or different polymers. The term “same polymer” as used herein refers to a polymer, e.g., polypropylene, with the same monomeric repeat units, e.g., propylene, but not necessarily the same physical properties, e.g., melting point, molecular weight, viscosity, etc. For example, a polypropylene with a melting point of 325° F. and a polypropylene with a melting point of 235° F. are the “same polymer” as used herein. Standard definitions for a particular polymer are not varied by this definition. For example, the term “polypropylene” as known to one of skill in the art is not altered by this definition.

In one aspect, the high melting polymer and the low melting polymer comprises a polyolefin, a polyamide, a polyester, a polyvinyl alcohol, a polyvinyl acetate, or polylactic acid. In another aspect, the high melting polymer and the low melting polymer is either polypropylene or polyethylene. In a further aspect, the high melting polymer comprises high-density polyethylene and the low melting polymer comprises low-density polyethylene. In another aspect, the high melting polymer comprises high-melt polypropylene and the low melting polymer comprises low-melt polypropylene.

In one aspect, the low melting polymer comprises a metallocene polypropylene. The tern “metallocene polypropylene” is defined herein as any polypropylene that was produced in the presence of metallocene catalyst. By selecting a particular catalyst and reaction conditions, it is possible to produce polypropylene with specific properties such as, for example, molecular weight, melting point, and tacticity. The procedures disclosed in U.S. Pat. No. 7,132,382 for using metallocene catalysts to prepare polypropylene can be used to produce metallocene polypropylenes useful herein. The metallocene polypropylene can be atactic, isotactic, hemi-isotactic, or syndiotactic.

In general, the low melting polymer of the second fabric has a melting point lower than that of the polypropylene of the first fabric. In one aspect, the difference in melting points between the fibers of the first fabric and the low melting polymer of the second fabric is greater than 25° C., greater than 30° C., greater than 40° C., greater than 50° C., greater than 60° C., or greater than 70° C. In another aspect, the difference in melting points between the fibers of the high melting polymer and the low melting polymer of the second fabric is greater than 5° C., greater than 10° C., greater than 20° C., greater than 30° C., greater than 40° C., greater than 50° C., greater than 60° C., or greater than 70° C.

In one aspect, when the low melting polymer is metallocene polypropylene, the metallocene polypropylene has a melting point less than 145° C., or from 120° C. to 145° C. In a further aspect, when the first fabric is composed of polypropylene and the low melting polymer is metallocene polypropylene, the melting point of the polypropylene of the first fabric is greater 165° C. and the melting point of the metallocene polypropylene of the second fabric is less than 145° C.

In one aspect, the low melting polymer has a melt flow index greater than 10 g/10 min@230° C. as measured by ASTM D1238. In another aspect, the low melting polymer has a melt flow index of from 10 to 100 g/10 min@230° C., from 30 to 90 g/10 min@230° C., from 40 to 80 g/10 min@230° C., or about 50 g/10 min@230° C. It is desirable that the low melting polymer completely melt upon thermal processing to ensure that the low melting polymer comes into intimate contact with the first fabric and the tufted carpet yarn.

When the low melting polymer is a metallocene polypropylene, the metallocene polypropylenes can be Polypropylene 1751 (a syndiotactic polypropylene with a MFI of 20 g/10 min as measured by ASTM D-1238 and melting point of 130° C.) and Polypropylene M3865 (an isotactic polypropylene with a MFI of 31 g/10 min as measured by ASTM D-1238 and melting point of 130° C.) both manufactured by Total Petrochemicals USA, Inc.

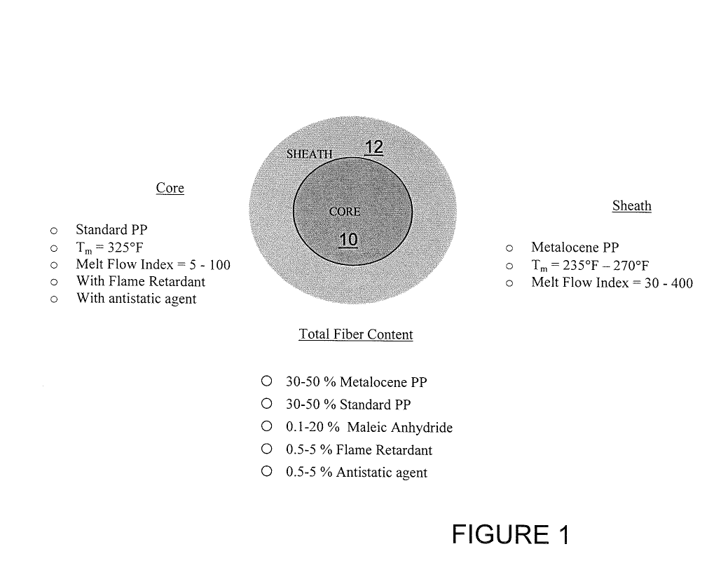

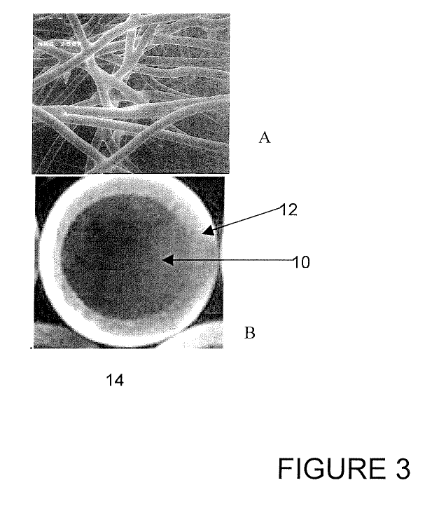

The fibers of the second fabric can be manufactured in a variety of forms. For example, the second fabric can be composed of a laminate of high melting polymer fibers adjacent to a layer of low melting polymer fibers. In one aspect, the second fabric is composed of fibers that are a blend of high melting polymer fibers and low melting polymer fibers. In another aspect, the second fabric is composed of bi-component fibers comprising a core and sheath, wherein the core comprises the high melting polymer and the sheath comprises the low melting polymer. Referring to FIG. 1, the bi-component fiber 14 is composed of a core 10 and sheath 12. In this aspect, the core is composed of polypropylene and the sheath is composed of metallocene polypropylene. In one aspect, the bi-component fiber depicted in FIG. 1 can be a 4 denier core comprising standard polypropylene and a 4 denier sheath comprising a metallocene polypropylene. FIG. 3A shows a photograph of a bi-component yarn 14 after heating to demonstrate adhesion properties and ability to flow. FIG. 3B shows a cross section of a bi-component fiber 14.

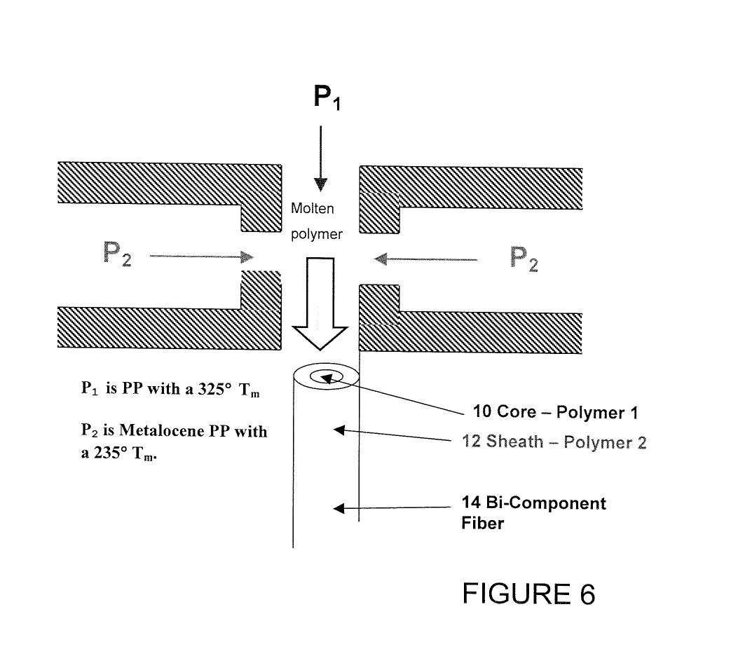

Bi-component fibers composed of a core and sheath can be prepared using techniques known in the art. Referring to FIG. 6, bi-component fiber 14 can be made by dual extruding a first thermopolymer as a core 10 and a second thermopolymer as a sheath 12 surrounding the core 10. For example, a dual extrusion head that generates a multiple polymer stream can be used. The first and second thermopolymer can be the same thermopolymer, e.g., each can be polypropylene. In one aspect, a metallocene low-melt polypropylene can be P₂ (the sheath 12), and a standard high-melt polypropylene can be P₁ (the core 10) of the bi-component fiber. In certain aspects, P₂ (the sheath 12) can contain additional components (e.g., a compatibilizer). P₁ (the core 10) can also contain additional components such as, for example, a flame retardant. Other additives such as, for example, dyes, antistatic compounds, antifungals, antimicrobials, and the like, can be incorporated in the sheath and/or the core.

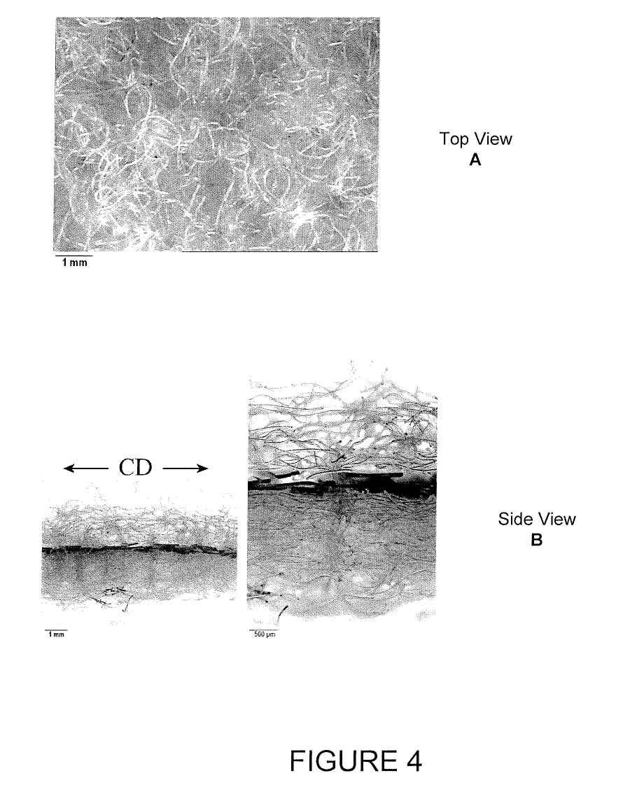

The second fabric can be prepared as a woven or non-woven fabric; however, non-woven fabrics are preferred. Techniques generally known for preparing woven and non-woven fabrics can be used to prepare the second fabric. FIG. 4A shows a top view of a single layer non-woven fabric comprising a mechanically bonded blend of low-melt fibers and high-melt fibers. FIG. 4B shows a side view of the single layer non-woven fabric shown in 4A (CD=cross direction).

In certain aspects, additional components can be incorporated in or used in combination with the bi-component fibers of the second fabric. In one aspect, a compatibilizer can be incorporated into the second fabric. The addition of a compatibilizer can be particularly useful when the tuft of the carpet is not the same polymer as that of the high and/or low melting polymers. In one aspect, the compatibilizer can be admixed with the low melting polymer prior to formation of the bi-component fiber. In another aspect, the low melting polymer can be modified with one or more groups to convert the low melting polymer to a compatibilizer. In other aspects, the compatibilizer can be applied to the second fabric by spraying, coating, or dipping the compatibilizer on the second fabric. In one aspect, the compatibilizer is intimately admixed with the metallocene polypropylene and extruded to produce fibers.

In one aspect, the compatibilizer comprises a polyolefin such as, for example, polypropylene, grafted with an unsaturated carboxylic acid, anhydride, ester, or any combination thereof. Examples of such acids and anhydrides include, but are not limited to, maleic acid, maleic anhydride and derivatives thereof such as citraconic acid, citraconic anhydride and pyrocinchonic anhydride; fumaric acid and derivatives thereof; unsaturated derivatives of malonic acid such as 3-butene-1,1-dicarboxylic acid, benzylidene malonic acid and isopropylidene malonic acid; and unsaturated derivatives of succinic acid such as itaconic acid and itaconic anhydride. Thus, as described above, it is contemplated that the low melting polymer can be a polyolefin grafted with an unsaturated carboxylic acid, anhydride, ester, or any combination thereof (a grafted polymer) or, in the alternative, the low melting polymer can be a mixture of grafted and ungrafted polyolefin.

In one aspect, the compatibilizer comprises maleic acid and maleic anhydride grafted onto a polyolefin. When these compounds are grafted onto the polyolefin, the resulting chain is provided with succinic acid or succinic anhydride groups, respectively. The grafting of the dicarboxylic acid, anhydride, or ester thereof onto a polyolefin may be performed using techniques known in the art. See U.S. Pat. Nos. 4,950,541 and 4,684,576, which are incorporated by reference for their teachings of grafting unsaturated carboxylic acids, anhydrides, and esters to polyolefins.

The amount of compatibilizer that is used in the second fabric can vary. In one aspect, the weight ratio of compatibilizer to low melting polymer in the second fabric is from about 1:99 to 50:50, from about 1.5:98.5 to 30:70, from about 2:98 to 20:80, from about 3:97 to 15:85, or from about 5:95 to 10:90. In one aspect, the amount of compatibilizer is about 7.5% by weight of a maleated polymer. The content of carboxylic acid, anhydride, or ester groups present in the compatibilizer can be in the range of about 1to 30% by weight, from about 2 to 20% by weight, from about 3 to 15% by weight, or from about 5 to 10% by weight of the compatibilizer.

In one aspect, the compatibilizer comprises a maleated random-polypropylene polypropylene copolymer sold as Fusabond MZ-278D by E.I. DuPont de Nemours & Company. Other examples of compatibilizers useful herein include maleated polyethylene wax sold by Eastman Chemicals, Inc. as “C-18,” or ethylene-acrylic acid copolymers containing 3 to 20 percent acrylic acid, available from Exxon Chemicals, and maleated polymers sold by Chemtura.

The primary backings described herein can further comprise other components typically used in the carpet industry including flame retardants, dyes, antimicrobials, antistatic compounds, antifungals, or any combination thereof. These additional components can be applied directly to the backing using techniques known in the art. In another aspect, these components can be added to the low melting polymer prior to the manufacture of the second fabric. In this aspect, the additional components (e.g., the compatibilizer) are evenly dispersed throughout the second fabric.

B. Methods

Described herein are methods for making primary carpet backings. In one aspect, the method comprises attaching a first fabric to a second fabric comprising a high melting polymer and a low melting polymer.

In another aspect, a method for making carpet comprises (a) tufting any of the primary backings described herein with yarn to produce a tufted article; (b) heating the tufted article at a temperature great enough to melt the metallocene polypropylene of the second fabric but less than the melting point of the polypropylene of the first fabric; and (c) cooling the tufted article so that the metallocene polypropylene binds to the tuft.

The primary backings described herein can be produced by physically attaching the first fabric comprising polypropylene to the second fabric. Methods for attaching the fabrics are known in the art. For example, the first and second fabrics can be placed side-by-side and exposed to heat such that the low melting polymer of the bi-components fibers melts and binds the second fabric to the first fabric. In another aspect, the second fabric is needle-punched to the first fabric. In this aspect, the needle of the needle puncher pushes the bi-component fibers into the first fabric. In one aspect, up to 10%, up to 15%, or up to 20% by weight of the bi-component fibers is pushed through the first fabric upon needle punching the second fabric to the first fabric. It is contemplated that two or more different second fabrics can be attached to the first fabric. For example, the first fabric can be disposed between two second fabrics. Here, the bi-component fibers of each second fabric can be the same polymer as defined herein or different polymers. Upon subsequent heating, the bi-component fibers that are inserted in and through the first fabric anchors the second fabric to the first fabric, which ultimately produces a stronger and more stable primary backing.

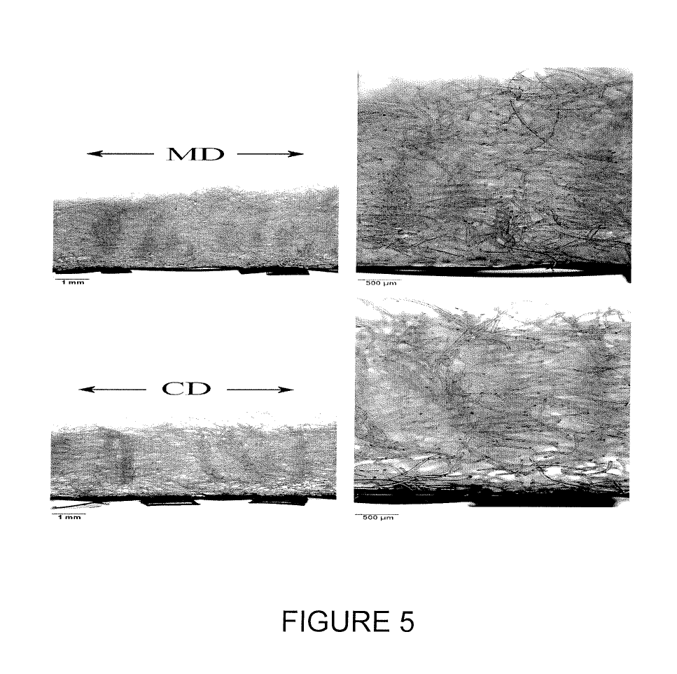

FIG. 5 shows a two-layer non-woven (second fabric) and woven (first fabric) backing. The top layer (second fabric) is a non-woven comprising a mechanically bonded blend of low-melt fibers and high-melt fibers. The woven layer comprises high-melt, high tenacity thermoplastic yarns, which provides a matrix for stability. As described above, the fibers of the second fabric are pushed into the woven fabric to expose them on the top and underside of the backing. This is done to further gain matrix adhesion and stability.

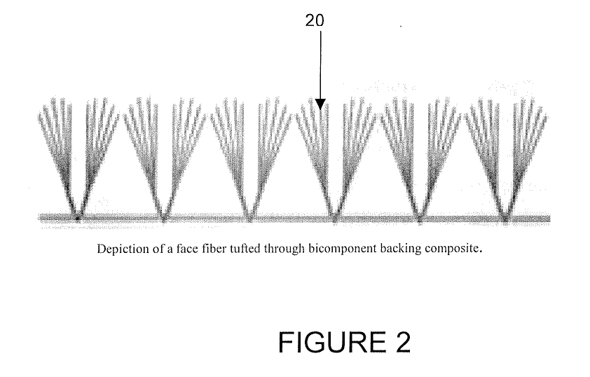

Once the primary backing is produced, the backing is tufted with carpet yarn. The yarn can be made of any fiber typically used to manufacture carpet, including polyolefins (e.g., polypropylene, polyethylene), polyesters, and polyamides. Techniques for tufting primary backings are known in the art and can be used herein. In one aspect, the yarn is tufted through the first fabric followed by the second fabric. FIG. 2 depicts yarn 20 tufted in a bi-component backing described herein.

In the embodiments described above, a fabric composed of bi-component fibers is attached to a first fabric to produce a primary backing. However, it is contemplated that a fabric of bi-component fibers can be used as the primary backing in the absence of the first fabric. Here, the fabric is tufted with carpet yarn using techniques known in the art.

After tufting the primary backing, the tufted article is heated to a temperature that melts the low melting polymer of the bi-component fibers of the second fabric but lower than the melting point of the high melting polymer. Upon reaching the melting point of the low melting polymer, the polymer begins to melt and flow. Here, the melted low melting polymer comes into intimate contact with the yarn and the first fabric. The temperature, pressure, and duration of heating will vary depending upon the selection of the low melting polymer. Techniques for heating the tufted article are known in the art. For example, hot drum laminators and conventional drying ovens can be used. In one aspect, the tufted article is heated in a tenter oven via an “s” wrap roll system or a two-roll nip with variable pressure control. In certain aspects, when a compatibilizer is not used, higher temperatures and pressures may be required. By not melting the high melting polymer, during thermal processing, this ensures good breathability of the final carpet. It is desirable for carpet to be breathable in some cases for odor, fungus, and cleanability purposes.

When the heat is removed, the low melting polymer solidifies and acts like an adhesive, which bonds the tuft to the first fabric. Thus, the tufts are locked in the first fabric without using conventional latex binders. This results in a 100% recyclable thermoplastic, latex free product. No subsequent processing steps are needed to produce a carpet having suitable properties for end use. For example, no subsequent drying is necessary, which is associated with the use of latex adhesive. Additionally, it is not necessary to use a secondary backing, which adds to increased production costs and overall weight of the carpet. Finally, carpet produced with the primary backings described herein has improved properties such increased tuft bind.

Another advantage of using the primary backings described herein is that the carpet can be recycled for future use. In one aspect, a method for recycling carpet comprises (a) heating the carpet comprising the primary backing described herein at a temperature to melt the carpet to produce a molten solid and (b) cooling the molten solid. The entire carpet is heated to the melting temperature of the face yarn where the backing will be converted to the molten state to produce a melt stream. In certain aspects, the carpet is chopped prior to heating. In the case when the carpet contains yarn made of fibers different from those used to produce the first and second fabrics, a compatibilizer present in the primary backing bonds to the Nylon in the melt stream. This melt stream is solidified and chopped into recycled pellets, which can be used as a raw material for other thermoplastic end uses. The methods for recycling carpet are particularly advantageous when the first fabric and the bi-component fibers of the second fabric are the same polymer. For example, when fibers of the first fabric and bi-component fiber are polypropylene, upon heating the molten solid is composed of only polypropylene and yarn material, which could also be polypropylene.

### EXAMPLES

The following examples are put forth so as to provide those of ordinary skill in the art with a complete disclosure and description of how the compounds, compositions, articles, devices, and/or methods described and claimed herein are made and evaluated, and are intended to be purely exemplary and are not intended to limit the scope of what the inventors regard as their invention. Efforts have been made to ensure accuracy with respect to numbers (e.g., amounts, temperature, etc.) but some errors and deviations should be accounted for. Unless indicated otherwise, parts are parts by weight, temperature is in ° C. or is at ambient temperature, and pressure is at or near atmospheric. There are numerous variations and combinations of reaction conditions, e.g., component concentrations, desired solvents, solvent mixtures, temperatures, pressures and other reaction ranges and conditions that can be used to optimize the product purity and yield obtained from the described process. Only reasonable and routine experimentation will be required to optimize such process conditions.

Procedure for Making Carpet

A general procedure is described below for making carpet using the backings described herein. Bi-component fiber composed of a polypropylene core and metallocene polypropylene sheath is made into a web from a card. The sheath can contain a nylon-polypropylene compatibilizer, e.g., maleated polypropylene, where the maleated polypropylene bonds and adheres to nylon in a melt stream. The web is cross-lapped with a non-woven fabric, which can form multiple stacked layers of the bi-component fibers. The stack is condensed by mechanically needling the layers to form a non-woven fabric between the weights of about 2 and about 20 OSY (ounces per square yard).

The non-woven is then calendared and heated to pre-consolidate and create a dimensionally stable fabric. This takes place by exceeding the temperature of the sheath for a short time before cooling. The fabric is then tufted with a face yarn such as a polyamide face yarn. The tufted fabric can be dyed, finished, and cured at a temperature exceeding the melting point of the lower melting sheath but below the melting point of the higher melting core. Once the fabric is cured, it is a finished carpet. Further steps are known in the art, such as trimming, inspecting, and packaging.

Throughout this application, various publications are referenced. The disclosures of these publications in their entireties are hereby incorporated by reference into this application in order to more fully describe the compounds, compositions and methods described herein.

Various modifications and variations can be made to the compounds, compositions and methods described herein. Other aspects of the compounds, compositions and methods described herein will be apparent from consideration of the specification and practice of the compounds, compositions and methods disclosed herein. It is intended that the specification and examples be considered as exemplary.

What is claimed:

1. A primary backing for carpet, wherein the primary backing comprises (1) a first fabric, and (2) a second fabric comprising a high melting polymer and a low melting polymer, wherein the high melting polymer and a low melting polymer are the same polymer, and wherein the first fabric and the second fabric are physically attached to one another.

2. The backing of claim 1, wherein the first fabric and the second fabric are needled-punched to each other.

3. The backing of claim 1, wherein the first fabric comprises a woven fabric or a non-woven fabric.

4. The backing of claim 1, wherein the first fabric comprises fibers of a polyolefin, a polyester, a polyamide, or a combination thereof.

5. The backing of claim 1, wherein the first fabric comprises fibers of polypropylene.

6. The backing of claim 1, wherein the second fabric comprises a non-woven fabric.

7. The backing of claim 1, wherein the high melting polymer and the low melting polymer comprises polyolefin, a polyamide, a polyester, a polyvinyl alcohol, a polyvinyl acetate, or polylactic acid.

8. The backing of claim 1, wherein the high melting polymer and the low melting polymer comprises polypropylene or polyethylene.

9. The backing of claim 1, wherein the high melting polymer comprises high density polyethylene and the low melting polymer comprises low density polyethylene

10. The backing of claim 1, wherein the high melting polymer comprises high-melt polypropylene and the low melting polymer comprises low-melt polypropylene.

11. The backing of claim 1, wherein the low melting polymer comprises metallocene polypropylene.

12. The backing of claim 1, wherein the low melting polymer has a melt flow index greater than 10 g/10 min at 230° C. as measured by ASTM D1238.

13. The backing of claim 1, wherein the low melting polymer is grafted with an unsaturated carboxylic acid, anhydride, ester, or any combination thereof.

14. The backing of claim 1, wherein the low melting polymer is grafted with citraconic acid, citraconic anhydride, pyrocinchonic anhydride, fumaric acid or a derivative thereof, 3-butene-1,1-dicarboxylic acid, benzylidene malonic acid, isopropylidene malonic acid, itaconic acid, itaconic anhydride, or any combination thereof.

15. The backing of claim 1, wherein the low melting polymer is grafted with maleic acid, maleic anhydride, or a mixture thereof.

16. The backing of claim 1, wherein the amount of carboxylic acid groups, anhydride groups, or ester groups grafted to the polymer is from 1 to 30% by weight of the low melting polymer.

17. The backing of claim 1, wherein the amount of carboxylic acid groups, anhydride groups, or ester groups grafted to the polymer is from 5 to 10% by weight of the low melting polymer.

18. The backing of claim 1, wherein the difference in melting points between the high melting polymer and the low melting polymer is greater than 20° C.

19. The backing of claim 1, wherein the melting point of the low melting polymer is less than 145° C.

20. The backing of claim 1, wherein the first fabric comprises polypropylene and the low melting polymer comprises metallocene polypropylene, wherein the melting point of the polypropylene of the first fabric is greater 165° C. and the melting point of the metallocene polypropylene of the second fabric is less than 145° C.

21. The backing of claim 1, wherein the low melting polymer comprises a mixture of polymer grafted with at least one carboxylic acid group, anhydride group, or ester group and a polymer not grafted with at least one carboxylic acid group, anhydride group, or ester group.

22. The backing of claim 21, wherein the ungrafted polymer comprises the same polymer as that of the low melting polymer.

23. The backing of claim 21, wherein the ungrafted polymer comprises polyethylene or polypropylene.

24. The backing of claim 1, wherein the weight ratio of the high melting material to that of the low melting material is from 10:90 to 90:10.

25. The backing of claim 1, wherein the weight ratio of the high melting material to that of the low melting material is from 30:70 to 70:30.

26. The backing of claim 1, wherein the second fabric comprises a layer of high melting polymer fibers adjacent to a layer of low melting polymer fibers.

27. The backing of claim 1, wherein the second fabric comprises a blend of high melting polymer fibers and low melting polymer fibers.

28. The backing of claim 1, wherein the second fabric is produced from fibers comprising a core and sheath, wherein the core comprises the high melting polymer and the sheath comprises the low melting polymer.

29. The backing of claim 1, wherein the backing further comprises a flame retardant, a dye, an antimicrobial, an antistatic compound, an antifungal, or any combination thereof.

30. The backing of claim 1, wherein the high melting polymer has a denier of about 2 to about 20 and the low melting polymer has a denier of about 2 to about 20.

31. A primary backing for carpet, wherein the primary backing comprises (1) a first fabric, and (2) a second fabric comprising a high melting polymer and a low melting polymer, wherein the low melting polymer is grafted with an unsaturated carboxylic acid, anhydride, ester, or any combination thereof, and wherein the first fabric and the second fabric are physically attached to one another.

32. The backing of claim 31, wherein the low melting polymer further comprises one or more polymers not grafted with an unsaturated carboxylic acid, anhydride, ester, or any combination thereof.

33. A carpet comprising the primary backing of claim 1.

34. The carpet of plain 33, wherein the carpet does not contain an adhesive.

35. The carpet of claim 33, wherein the carpet does not contain a secondary backing.

36. A carpet comprising the primary backing of claim 31.

37. A carpet comprising carpet yarn tufted into a fabric comprising a high melting polymer and a low melting polymer, wherein the high melting polymer and a low melting polymer are the same polymer.

38. A method of producing a primary backing comprising attaching a first fabric and a second fabric comprising a high melting polymer and a low melting polymer, wherein the high melting polymer and a low melting polymer are the same polymer.

39. A method of producing a primary backing comprising attaching a first fabric and a second fabric comprising a high melting polymer and a low melting polymer, wherein the low melting polymer is grafted with an unsaturated carboxylic acid, anhydride, ester, or any combination thereof.

40. A method of producing carpet comprising (a) tufting the backing of claim 1 with yarn to produce a tufted article; (b) heating the tufted article at a temperature great enough to melt the low melting polymer but less than the melting point of the high melting polymer; and (c) cooling the tufted article so that the low melting polymer binds to the tuft.

41. A method of producing carpet comprising (a) tufting the backing of plain 31 with yarn to produce a tufted article; (b) heating the tufted article at a temperature great enough to melt the low melting polymer but less than the melting point of the high melting polymer; and (c) cooling the tufted article so that the low melting polymer binds to the tuft.

42. A method of recycling carpet comprising (a) heating the carpet comprising the primary backing of claim 1 at a temperature to melt the carpet to produce a molten solid and (b) cooling the molten solid.

43. A method of recycling carpet comprising (a) heating the carpet comprising the primary backing of claim 31 at a temperature to melt the carpet to produce a molten solid and (b) cooling the molten solid.
